(19) United States
(12) Patent Application Publication
(10) Pub. No.: US 2016/0131805 A1
(43) Pub. Date: May 12, 2016

(54) DEFORMED LENTICULAR MATERIAL GRAPHICS FOR AN ARTICLE OF FOOTWEAR UPPER

(71) Applicant: NIKE, INC., BEAVERTON, OR (US)

(72) Inventors: MARK SMITH, PORTLAND, OR (US); ADAM WELLIVER, BEAVERTON, OR (US)

(21) Appl. No.: 14/534,856

(22) Filed: Nov. 6, 2014

(51) Int. Cl. G02B 3/00; B29D 11/00; A43B 23/02; G02B 27/22; A43B 3/00

(52) U.S. Cl. CPC G02B 3/005; G02B 27/2214; A43B 3/0078; A43B 23/0205; B29D 11/00298; B29K 2075/00

(57) ABSTRACT

The present aspect is directed to lenticular material having both partially deformed lenticules and intact lenticules extending from a substrate. The intact lenticules operate to create an optical effect to enhance background graphical elements placed upon a substrate opposite the intact lenticules. The height of portions of some lenticules are reduced or deformed, thereby disrupting the optical effect. The placement of deformed portions of lenticules is used to create primary graphical elements lacking the optical effect. These primary graphical elements are accentuated by the neighboring intact lenticules, which retain the optical effect regarding the background graphical elements.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The present aspect relates to a lenticular material with graphics for a shoe upper. More specifically, the present aspect relates to the use of partially deformed lenticular materials as a shoe upper.

### BACKGROUND

Lenticular materials are generally employed for the desired optical effects that may be created using the lens thereon. However, deforming or misshaping one or more lenses of a lenticular material may reduce and/or destroy a traditionally desired optical effect.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The present aspect is defined by the claims.

Shoe uppers may be comprised of one or more materials having desirable qualities. For example, various materials and combinations of materials may promote air circulation, moisture wicking, and/or visibility, among other characteristics.

At a high level, the present aspect is directed toward a shoe upper composed of partially deformed lenticular material. Generally, the lenticular material is at least partially transparent, depending on composition. Lenticular material may be comprised of thermoplastic polyurethane, for example. The lenticular material has an exterior surface with an array of lenticular lenses and an interior surface. In aspects, more than one graphical element, such as an image, for example, is cut into narrow strips, spliced together in an alternating sequence, and affixed upon the interior surface of the lenticular material. For example, a strip of a first image is placed adjacent to a strip of a second image, which is placed adjacent to a strip of a third image. The sequence or pattern of placing a first image strip followed by a second image strip, and followed by a third image strip, may be repeated. Additionally, the strips belonging to each particular and separate image are sequentially ordered when interlaced with the other images' strips. And, the narrow strips are generally spliced together such that the strips are parallel, in a lengthwise direction, to the lenticular lenses of the exterior surface, in aspects. In other aspects, the more than one graphical element may be cut into another shape type and interlaced to correspond to the array of lenticular lenses. As such, the interlaced sequential strips of more than one graphical element may be viewed through the transparent or semi-transparent exteriorly placed array of lenticular lenses to achieve a desired optical effect, increased visibility, and/or to draw the eye to the shoe, for example. For example, when the shoe upper is viewed from a first angle, a complete first image is visible, whereas when the shoe upper is viewed from a second angle, a complete second image is visible. In this manner, shifts, morphs, animations, and three-dimensional (3-D) optical effects may be achieved.

The lenticular material of the shoe upper includes, exteriorly, at least one intact lens in the array and at least one partially or completely deformed lens in the array. The lenticular lenses that remain intact create a first desired optical effect by generally magnifying the interlaced (or otherwise oriented) graphical elements of the interior surface (e.g., by controlling which of the more than one graphical elements is visible, based on an observer's viewing angle). The lenticular lens or lenses, which are at least partially deformed, however, disrupt or interrupt the first optical effect by obscuring at least a portion of the visibility of a graphical element underlying said deformed lenses from at least one viewing angle. Deformed portions of the lenses composing the array may form or create a second desired optical effect (e.g., a primary graphical element). For example, when the shoe upper is viewed exteriorly, the deformed lenses together may form any of a graphical element, a pattern, a shape, a number, a letter, a character, a silhouette, a word, a logo, etc. Thus, with the present shoe upper, more than one desired optical effect may be achieved by utilizing both intact and deformed portions of the exterior, lenticular surface of the lenticular array, in aspects.

A shoe upper may, for example, have increased visibility due to contrast created between intact portions of the lenticular material as juxtaposed with or adjacent to deformed portions of the lenticular material. Additionally, optical effects of the partially deformed and intact lenticular materials may be enhanced by the natural contours and shape of the shoe upper itself. In aspects, optical effects may be enhanced as both the deformed and intact portions of the lenticular material bend, flex, and move during wear of the shoe. For example, an observer may see a graphic change and/or a color flash when a wearer runs by the observer. Additionally, deformed portions of the lenticular material create stationary or fixed graphical elements that may be complemented and/or highlighted by the intact portions of the lenticular material. For example, an observer may see a logo composed of deformed portions from all viewing angles when a wearer runs by the observer. In this example, the logo is visually emphasized as displayed against the background of graphical elements composed of intact portions, which may produce a graphic shift and/or a color change based on the viewing angle of the observer. Additional features of the partially deformed lenticular material of the shoe upper may include improving the visibility of the shoe upper during display in a commercial setting, for example, and/or during wear.

### BRIEF DESCRIPTION OF THE DRAWINGS

Examples are described in detail below with reference to the attached drawing figures, wherein:

FIG. 1 depicts a front perspective view of an exemplary shoe in accordance with an aspect hereof;

FIG. 2 depicts a side perspective view of an exemplary lenticular material having a substrate and an array, in accordance with an aspect hereof;

FIG. 3A depicts a cross-section view of an exemplary lenticular array and substrate as a material for a shoe upper, illustrating an intact lenticular lens in accordance with an aspect hereof;

FIG. 3B depicts a cross-section view of an exemplary lenticular array and substrate as a material for a shoe upper, illustrating a deformed lenticular lens in accordance with an aspect hereof;

FIG. 3C depicts a cross-section view of an exemplary lenticular array and substrate as a material for a shoe upper, illustrating a deformed lenticular lens in accordance with an aspect hereof;

FIG. 4A depicts a top plan view of an exemplary lenticular array and substrate as a material for a shoe upper, illustrating visibility of graphical elements in accordance with an aspect hereof;

FIG. 4B depicts a top plan view of an exemplary lenticular array and substrate as a material for a shoe upper, illustrating visibility of graphical elements in accordance with an aspect hereof;

FIG. 5 depicts a cross-section view of an exemplary lenticular array and substrate as a material for a shoe upper, illustrating a lenticular lens in accordance with an aspect hereof;

FIG. 6 depicts a cross-section view of an exemplary lenticular array and substrate as a material for a shoe upper, illustrating a lenticular lens in accordance with an aspect hereof;

FIG. 7 depicts a cross-section view of an exemplary lenticular array and substrate as a material for a shoe upper, illustrating a lenticular lens in accordance with an aspect hereof; and

FIG. 8 depicts a method for deforming a lenticular array, in accordance with an aspect hereof.

### DETAILED DESCRIPTION

At a high level, the present aspect is directed to a partially deformed lenticular material for a shoe upper. A shoe upper may be constructed of carious materials, including lenticular materials, which may provide eye-catching visibility using optical effects. The lenticular material disclosed herein, however, provides for lenticular materials having deformed portions. Deformed portions may be used to create primary graphical elements on the shoe upper that are further visibly emphasized by the optical effects of intact portions of the lenticular materials. For example, the contrast between the primary graphical elements formed by deformed portions, with reduced or no optical effect, draws the eye toward the primary graphical elements. Additionally, the visual contrast may promote visibility of the shoe upper during wear or when on display.

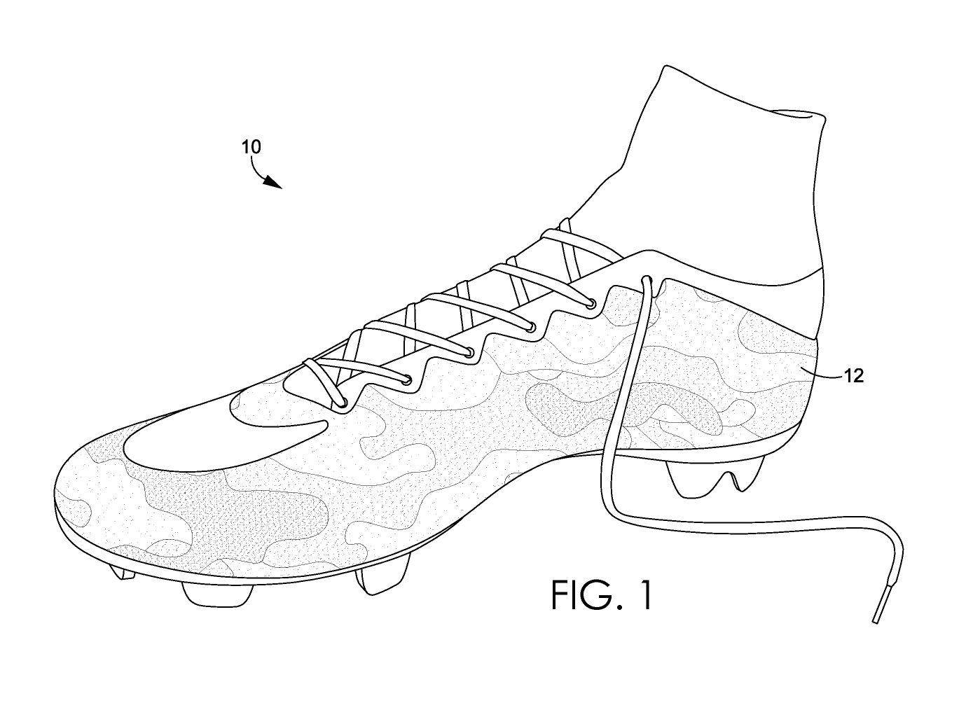

As shown in FIG. 1, an exemplary shoe 10 is depicted in a side perspective view, in accordance with aspects hereof. Exemplary shoes might include athletic shoes, sandals, dress shoes, boots, loafers, and the like. The term “footwear” and/or “shoe” may be used herein for simplicity, in reference to various examples of shoes. However, concepts described herein may be applied to a variety of other types of footwear. As illustrated, the exemplary shoe 10 comprises an upper 12. The exemplary upper 12 depicted in FIG. 1 may comprise any number of features based on aesthetics and/or functions of the shoe 10. Exemplary features might comprise any number of laces, eyelets, zippers, straps, hook-and-loop fasteners, draw strings, cord locks, hooks, elastics, and/or buckle elements (e.g., frame, tongue, and pin terminal). In aspects described herein, at least a portion of the exemplary upper 12 includes a lenticular material 18. The exemplary upper 12 may further include additional breathable materials, wicking fabrics, stabilizing components, and/or elastic elements for comfort and/or tailoring the fit of the shoe 10, in further aspects. The exemplary upper 12 might comprise any number of design features that aesthetically enhance the shoe 10. Although the upper 12 depicted in FIG. 1 is presented in a simplified fashion for illustrative purposes, in practice, the upper 12 may comprise any number of individual parts (e.g., collar, backstay, heel counter, heel tab, lining, quarter, vamp, tongue, eyelet stay, toe cap, foxing, etc.) comprising a variety of different materials.

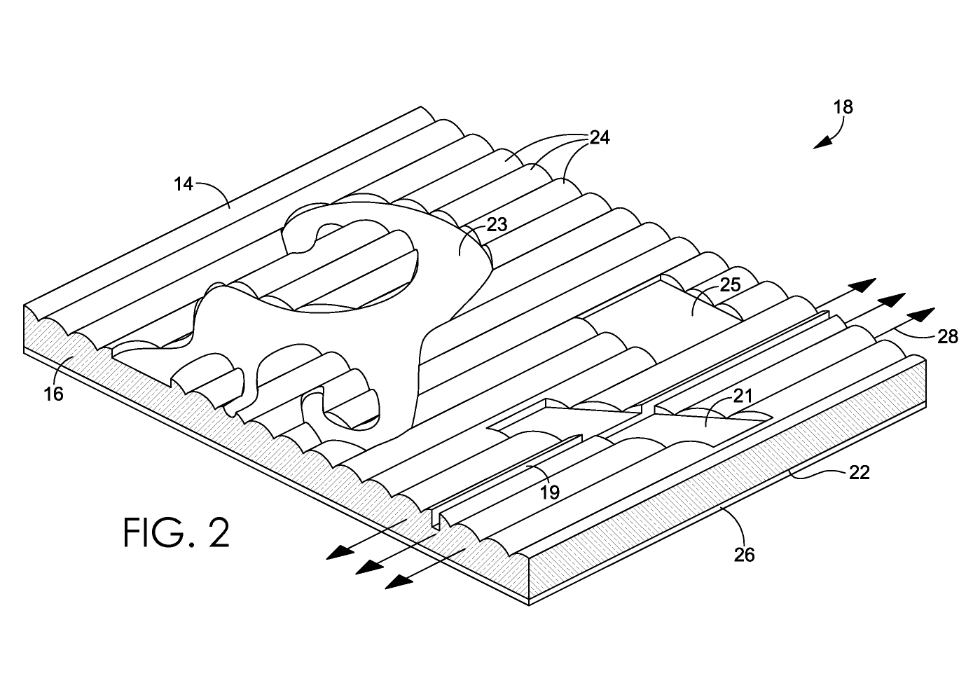

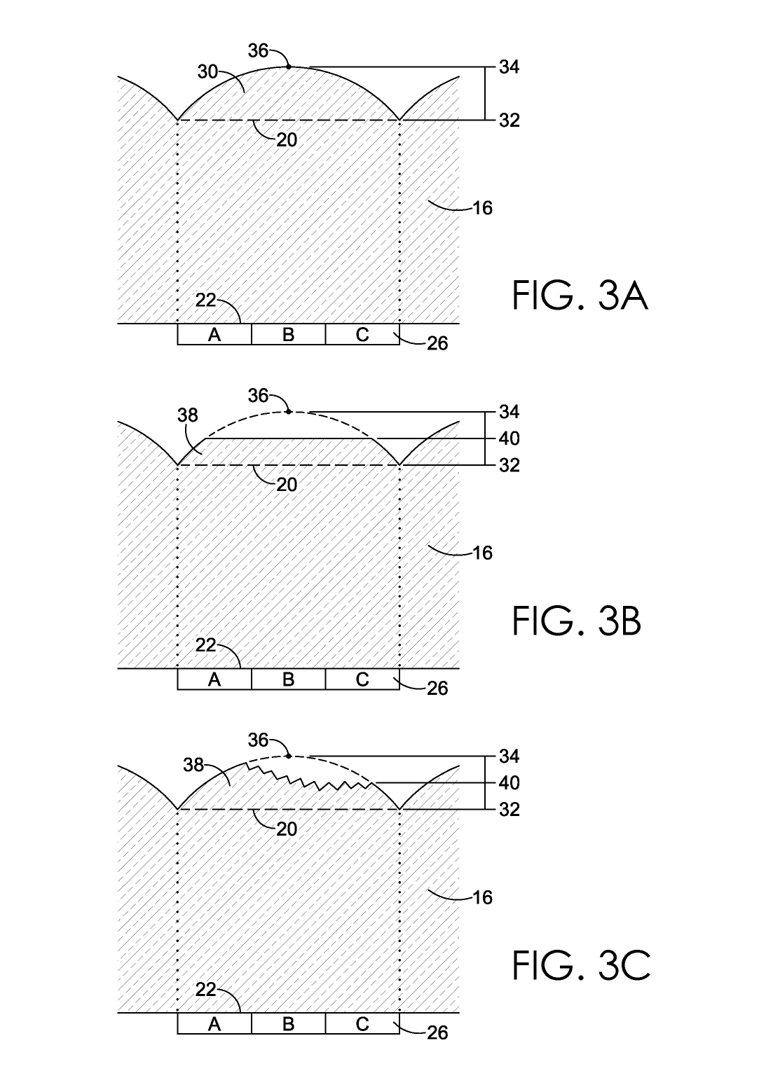

As shown in FIG. 2, a side perspective view of an exemplary lenticular array 14 and substrate 16 as a material 18 for a shoe upper 12 is depicted. For simplicity, the terms “lenticular array” and/or “array” may be used interchangeably herein. Additionally, the terms “lens” and/or “lenticule” may be used interchangeably herein, as well. The material 18 includes a substrate 16 and a lenticular array 14. The substrate may comprise one or more semi-transparent or transparent mediums. The substrate 16 includes a first surface 20 (see FIG. 3) and second surface 22 opposing the first surface 20. The first surface includes a lenticular array 14 having a plurality of lenses 24. The plurality of lenses 24 extend upward from the substrate 16. In aspects, the plurality of lenses 24 is formed integrally with the substrate 16. In such aspects, the lenses 24 and the substrate 16 may comprise the same or similar semi-transparent or transparent medium(s). In other aspects, the plurality of lenses 24 are not integrally formed with the substrate and/or first surface 20 of the substrate 16 from which the lenses 24 extend. In such aspects, the lenses 24 may be coupled to or affixed to the substrate 16. The plurality of lenses 24 may be adjacent to, abut, or contact the first surface 20 of the first surface 20 and/or the substrate 16. Generally, each of the plurality of lenses 24 is configured to receive light and transport light through the substrate 16 to the second surface 22, wherein one or more graphical elements 26 have been affixed. Exemplary lenses include convex, plano-convex, biconvex, meniscus, magnifying, Fresnel, spherical, or aspheric lens types. Each of the plurality of lenses 24 is generally the same or similar in size, shape, placement, and orientation. For example, each of the plurality of lenses 24 may be described as having a partial elliptic cross section about a lengthwise axis 28 (e.g., from the center of curvature). In some aspects, the partial elliptic cross section is circular and defined by a height and/or radius. Alternatively, the elliptic cross section may be defined by a major and minor axis. The cross section may be parabolic, oblate, or circular, in various aspects. In aspects, each of the plurality of lenses 24 may further extend along their respective lengthwise axis 28 to form partial elliptic cylinders. In aspects, each of the plurality of lenses 24 is substantially evenly spaced in a repeating fashion across the first surface 20 of the substrate 16. Additionally, the extension of the partial elliptic cylinder-shaped lenses along a respective lengthwise axis 28 is such that the cylindrical quality of each of the repeating plurality of lenses 24 is parallel, or substantially parallel, to one another. As such, the evenly spaced repeating placement of the partial elliptic cylinder-shaped lenses as parallel to one another may lend directionality to the lenticular material 18 such that a ‘grain’ is formed by the plurality of lenses 24 that extend from the substrate 16, in some aspects. The direction of ‘grain’ formed by the alignment of the repeating plurality of lenses 24 may further determine the type of optical effects that may be achieved and, further, may determine how the plurality of lenses 24 may be intentionally deformed so as to impede optical effects. For example, laser etching deformations into the lenticular array 14 may be performed perpendicular to the grain of the array 14 or perpendicular to a respective lengthwise axis 28 or the grain. In another example, shearing deformations into the lenticular array 14 may be performed parallel and/or perpendicular to the grain of the array 14. At least a portion of the first surface 20 is substantially covered by the plurality of lenses 24, which may be evenly spaced and repeating, extending from the substrate 16, in some aspects.

In aspects, at least one portion of a lens within the plurality of lenses 24 is deformed. In further aspects, portions of more than one lens within the plurality of lenses 24 are deformed. Generally, a lens may be deformed by flattening, deforming, and/or removing some or all of the curvature of the lens at one or more places along the length of the lens, for example. Deformed portions 19, 21, 23 and 25 may be of any shape, size, configuration, or depth, and may include a single lens or multiple lenses within the array 14. For example, deformed portion 19 may have a greater depth of deformation than deformed portion 21. In other examples, most or all the deformed portions may have the same or similar depth of deformation. Each of the deformed portions 19, 21, 23 and 25 may be deformed at one or more depths into the lenses' surface. A deformed portion may include various depths, creating one or more slopes, inclines, and/or declines. Each of the deformed portions 19, 21, 23 and 25 may be an isolated portion, may abut other deformed portions, and/or may intersect another deformed portion, for example. In yet further aspects, the deformed portions 19, 21, 23 and 25 may be shaped, sized, and/or otherwise configured to enhanced and/or obscure one or more graphical elements 26.

The second surface 22 of the substrate 16 is located opposite the first surface 20. Generally, one or more graphical elements 26 are affixed upon or adjacent the second surface 22 such that the one or more graphical elements 26 face the interior of the substrate 16 and, further, the first surface 20 having lenses. The one or more graphical elements 26 may include one or more images, patterns, or designs, for example. In aspects, a first, second, and third image are each dissected into long, narrow strips. These strips are then spliced together, adjacent to one another. For example, a strip from the first image is placed adjacent to a strip from the second image. Further, the strip from the second image is then placed adjacent to a strip from the third image. As such, a repeating sequence or pattern of strips is formed using the first, second, and third images that are part of the graphical elements 26 of the second surface 22. Importantly, the next consecutive or sequential strip from the first image will be placed adjacent to the strip from the third image. And, the next consecutive or sequential strip from the second image will be placed adjacent the second strip of the first image, and so on. As such, the image strips of the three images are interlaced with each other in a repeating pattern (e.g., 1, 2, 3, 1, 2, 3, etc.). The repeating order of the image strips is continued across the second surface 22 of the substrate 16.

One complete image cycle includes one strip from each image used in the lenticular material 18. In aspects, where the lenticular material 18 creates a flip as a first optical effect, one complete image cycle includes one strip from each of two images, for example. In some aspects, one complete image cycle is affixed to the second surface 22 so that the one complete image cycle corresponds to one individual lenticular lens opposite the one complete image cycle on the second surface 22. Each of the plurality of the lenses 24 of the array 14, for example, may correspond to one complete image cycle. In various aspects, the size, shape, and orientation of the image strips may correspond to a size, shape, pitch, and orientation of the plurality of lenses 24 of the first surface 20, for example.

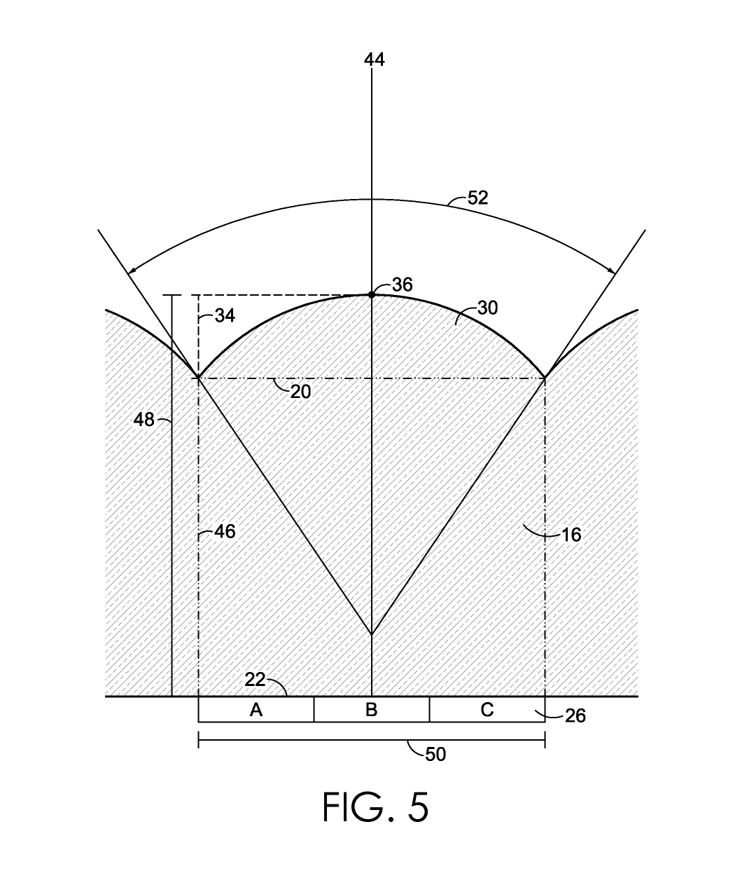

As described, both the array 14 and the substrate 16 may be composed of one or more transparent or semi-transparent materials or mediums. As such, light may travel through each of the plurality of lenses 24 to reach the second surface 22 of the substrate 16, whereon graphical elements 26 may be affixed or positioned proximate thereto. Each lens may magnify or focus upon one or more graphical elements 26 corresponding to said lens, such that the one or more graphical elements 26 may be visible to an observer based upon viewing angle. A viewing angle describes the angle from which an observer views the array 14 and each lens therein. Particular viewing angles and viewing angle ranges may be determined by the function of the lenticular material 18 and manufacturing limitations. Further optical mechanics will be described with regard to FIGS. 5, 6, and 7 hereinafter.

When the array 14 of the lenticular material 18 of the shoe upper 12 is viewed as a whole, the array 14 produces a sequence or variety of complete graphical elements 26 for an observer based on the viewing angle of the observer, in an exemplary aspect. In aspects, the array 14 produces a first complete image for an observer at a first viewing angle and a second complete image for the observer at a second viewing angle. A complete image describes the visible effect created when a plurality of image strips, all belonging to a single particular image and all being viewed together from the same viewing angle, are arranged in a sequence that creates a coherent and complete image. As such, the viewing angle determines which image strip of a graphical element 26 is visible to an observer from a viewing angle, for each individual lens of the array 14. As such, at the first observation angle, the combination of consecutive or sequential image strips belonging to the complete first image is visible through the array as a whole, or the complete first image is visible to the observer. Therefore, as the viewing angle of the observer changes, either by movement of the observer and/or movement of the array 14, the visibility of each of the complete first image and the complete second image changes as well. As arranged, all image strips belonging to the complete first image will be visible to an observer from a first viewing angle, while all image strips belonging to the complete second image will be visible to an observer from a second viewing angle, in aspects. In some aspects, the first and second viewing angles comprise two separate and different angle ranges of a full angle of observation of an individual lens. In other aspects, the first and second viewing angles comprise two angle ranges that overlap regarding a full angle of observation. Alternatively, the array 14 may produce only a single complete image that is intentionally distorted as the viewing angle changes. As such, the single complete image may appear to shift or morph as the viewing angle changes.

As such, the display of the complete first image appears to change to the display of the complete second image as an observer's viewing angle of the lenticular material 18 moves from left to right (e.g., lateral tracking). In another aspect, the display of the complete first image appears to change to the display of the complete second image as an observer's viewing angle of the lenticular material 18 moves from top to bottom (e.g., vertical tracking). Any number of images may be utilized depending on the desired optical effect. In further aspects, the array 14 may produce a flip, shift, morph, animation, zoom, full motion, three-dimension optical effect, or a combination thereof. For example, a flip effect appears to flip from one image to another. In another example, a three-dimensional effect creates the illusion of depth to an observer by offsetting various portions of graphical elements 26 and/or image strips at different increments, such that portions of graphical elements 26 appear to be placed at a different depth or layer. A morph effect appears to gradually change from one image to another, through a series of images, in a further example. The illusion of motion, a zooming action, and/or animation may also be achieved using lenticular materials. As will be apparent to those skilled in the art, various dimensions, compositions, and/or materials may be employed in the array 14 to achieve said effects.

Further, the various optical effects may be interrupted, to varying degrees, by deforming a portion of an individual lens in the array 14. In aspects, at least a portion of the partial elliptic cross section of one or more lenses is flattened, removed, altered, or the curvature is otherwise reduced, for example. As such, the one or more intentionally deformed portions of the partial elliptic cross section of lenses 24 receive and transport light into and out of the substrate 16 differently than before deformation. The deformed portions may impair a magnification function by changing the focal length, back focal distance, optical power, height, thickness, and/or radius or radii of the lens. By altering and/or impeding any or all of these lens characteristics, the visibility of a particular image strip corresponding to graphic elements 26 through the lenses is altered.

The portion of the partial elliptic profile may be intentionally deformed by heat pressing, embossing, mechanically excising, shearing, or otherwise obliterating the portion, for example. One or more deformed portions may be located anywhere along the elliptic cross section of a lens. In one aspect, more than half of the elliptic curvature may be deformed by uniformly flattening the curvature. In another aspect, more than one portion of the elliptic curvature may be deformed by cutting away portions to create divots. The apex or peak of the elliptic curvature may be embossed to deform the lens, in another aspect. The deformed portion may be centrally located along the peak of the curvature of the elliptic cross section and/or, alternatively, may be located along other areas of the curvature, in aspects.

Turning to FIG. 3A, it depicts a cross-section view of an exemplary lenticular array 14 as a material 18 for a shoe upper 12, the array 14 having an intact lenticular lens 30. For the purposes of reference to the cross section, the lenticular array 14 includes a plurality of lenses 24, as previously described herein, each having a base 32 and a first height 34 extending from the substrate 16. The exemplary intact lenticular lens 30, as shown, has a partial elliptic cross section about a lengthwise axis 28. The base 32 of the lens 30 is adjacent to the first surface 20 of the substrate 16. The base 32 of the intact lens 30 is generally located above the bulk of the thickness of the substrate 16 and serves as the platform from which the lens 30 extends outward. The lens 30 has a first height 34 that describes the distance from the base 32 of the lens 30 at the first surface 20 of the substrate 16 to the apex 36 of the curvature of the lens 30, in aspects. In some aspects, the first height 34 of the lens 30 having a partial elliptic cross section may correspond to a first radius. The first radius may be defined as the distance from the center of the curvature of the lens 30 to a point along the surface of the cross section of the curvature of the lens 30.

In contrast to FIG. 3A, FIG. 3B depicts a cross-section view of an exemplary lenticular array 14 as a material 18 for a shoe upper 12, the array 14 having a lenticular lens 38 that is deformed. As shown, at least a portion of the cross section of the lens 38 of the plurality of lenses 24 has been deformed to a second height 40. As partially deformed, disfigured, and/or otherwise altered, the lens 38 has a base 32 and a second height 40 that is not the same as the first height 34 of an intact or non-deformed lens 30, for example. Methods of deformation include laser etching, heat pressing, mechanical embossing, excising material from the surface of the curvature, melting the lens material of the substrate 16, and/or other reduction or subtraction techniques. For example, the melt temperature of the lens material may be a particular temperature and/or a range of temperatures (e.g., at and/or around 145 degrees Celsius). In further aspects, the melt temperature or melt temperature range of the lenticular material may be outside (e.g., above or below) of a temperature and/or temperature range used for fusing the upper of the footwear itself to other footwear components, for heat fusing toe or heal reinforcements, etc. As such, deforming and/or melting the lenticular material may be done without interfering with other construction or element of the footwear. The partial deformation of the lens 38 may be uniform, for example, as shown in FIG. 3B. Alternatively, the deformed portions of the lens 38 may be asymmetric, uneven, or otherwise non-uniform, as illustrated in FIG. 3C, for example. The at least one deformed portion may be centrally located so as to remove or destroy the apex 36 or peak of the curvature of the lens 38, in some aspects. In other aspects, the at least one deformed portion may be offset. In yet further aspects, the at least one deformed portion may be located on the periphery of the cross section of the lens 38. In further aspects, more than one portion of a lens 38 is deformed along the curvature. The placement, extent, and depth of one or more deformed portions of the lens 38 may be determined so to interrupt a first optical effect near the location of the one or more deformed portions, the effect with regard to the one or more graphical elements 26. A first optical effect might include a flip, shift, morph, animation, zoom, full motion, three-dimension optical effect, or a combination thereof, for example.

Generally, the second height 40, resulting from the deformation of at least a portion of the elliptic cross section of the lens 38, is less than the first height 34, in aspects. In some aspects, the second height 40 of a lens 38 having a partial elliptic cross section may correspond to a second radius. The second radius may be defined as the distance from the center of the curvature of the lens 38 to a point along the curvature of the lens' surface, located at the second height 40. In further aspects, the second radius may be less than a first radius corresponding to the first height 34. In some aspects, the deformation of the at least a portion of cross section of a lens 38 of the plurality of lenses 24 to the second height 40 is perpendicular to the cross section, as shown in FIG. 3B, for example.

A difference between the first height 34 and the second height 40 may impair, interrupt, and/or impede a first optical effect of the deformed lens 38 corresponding to graphical elements 26 affixed to the second surface 22 of the substrate 16. By reducing the height of the lens 38 from the first height 34 to the second height 40, characteristics of the deformed lens 38 are affected. Exemplary characteristics that may be affected by deformation include the focal length, back focal distance, optical power, height, thickness, and/or a radius or radii of the lens. Alteration of any or all of these characteristics may interfere with or obliterate a first optical effect of the particular deformed lens 38. Additionally, alteration of any or all of these characteristics may be utilized to form a primary graphical element that is accentuated by the first optical effect created by intact lenses within the array 14.

Referring to FIG. 3C, it depicts a cross-section view of an exemplary lenticular array 14 as a material 18 for a shoe upper 12, the array 14 having a lenticular lens 38 that is deformed. As shown in the cross section, at least one portion of the elliptic cross section of the lens 38 may be deformed in an uneven, asymmetric manner, jagged, or otherwise non-uniform manner. In aspects, the deformed portion may be created by laser etching, mechanically embossing, shearing, excising, obliterating, melting of the lens substrate 16, and/or other reduction or subtraction methods. Methods of deformation, previously mentioned herein, may be used or determined based on a melting temperature of the medium of the lens and/or a melting temperature of the material of the substrate 16. Additionally or alternatively, a method of deformation may be utilized in order to facilitate a particular type of deformation and/or, based on the size, shape, arrangement, and/or detail of the primary graphical elements, be formed by one or more deformed portions. In some aspects, more than one portion of the lens 38 is deformed, in a uniform manner, an uneven manner, or combination thereof.

Additionally, in FIGS. 3A-3C, image strips A, B, and C, each strip corresponding to different whole images within the graphical elements 26, are illustrated as affixed to the second surface 22 of the substrate 16. As shown, each lens 30 and 38 has corresponding image strips A, B, and C located opposite each lens 30 and 38 on the second surface 22. Image strip A corresponds to a slice of a complete first image, image strip B corresponds to a slice of a complete second image, and image strip C corresponds to a slice of a complete third image, for example. Each lens 30 and 38 within the array 14 includes a strip from each of the complete first, second, and third images. As such, with regard to each separate lens 30 and 38, image strip A may be visible to an observer from a first viewing angle, image strip B may be visible to the observer from a second viewing angle, and image strip C may be visible to the observer from a third viewing angle, for example. With regard to the array 14 as a whole, the observer may view the complete first image from the first viewing angle, the complete second image from the second viewing angle, and the complete third image from the third viewing angle, in aspects.

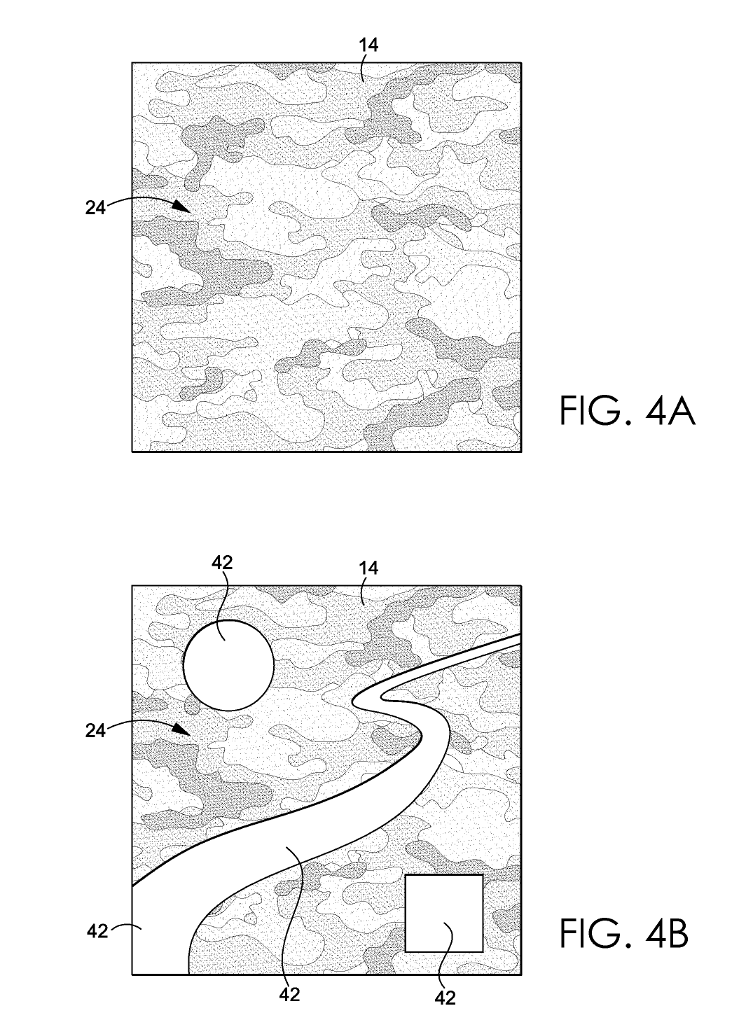

Turning now to FIGS. 4A and 4B, a top plan view of an exemplary lenticular array 14 as a material 18 for a shoe upper 12 is depicted for illustrating visibility of graphical elements. In FIG. 4A, graphical elements have been affixed to the second surface 22 of the substrate 16, facing the interior of the substrate 16 and/or bases of the lenses within the array 14. As such, the graphical elements are visible through the plurality of lenses 24 comprising the array 14, depending on a viewing angle, as previously described. In FIG. 4B, portions of the plurality lenses 24 of the array 14 have been deformed to impede and disrupt the first optical effect with regard to those deformed portions. As shown, when the array is viewed as a whole, the deformed portions 42 of the array 14 may be arranged to create primary graphical elements, a pattern, a shape, a number, a letter, a character, a silhouette, a word, a logo, etc., wherein the primary graphical elements lack the first optical effect. Further, the primary graphical elements are highlighted, accentuated, or emphasized by the first optical effect and the graphical elements 26 affixed to the second surface 22 of the substrate 16, which create a visually interesting background for the primary graphical elements comprised of deformed portions 42. For example, a graphic change or color flash of the first optical effect may enhance the visibility of the primary graphical elements created by the deformed portions 42 of the array 14. In further aspects, a glaze or other coating (e.g., shoe polish, semitransparent paint) is added to the array 14 which darkens the deformed portions, or alternatively darkens the non-deformed portions, in order to promote greater contrast between the deformed portions and non-deformed portions of the array 14.

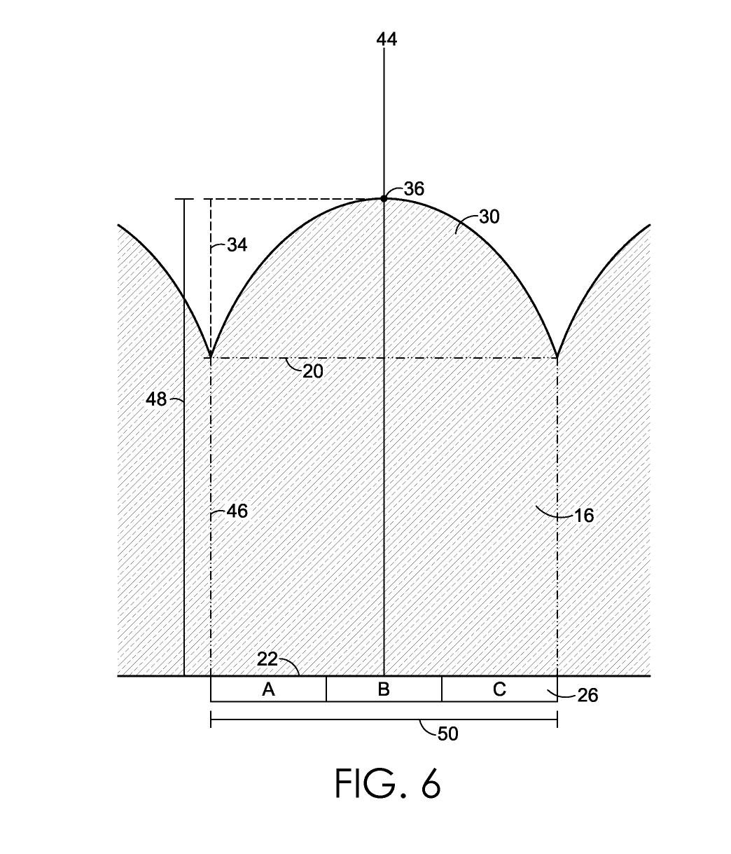

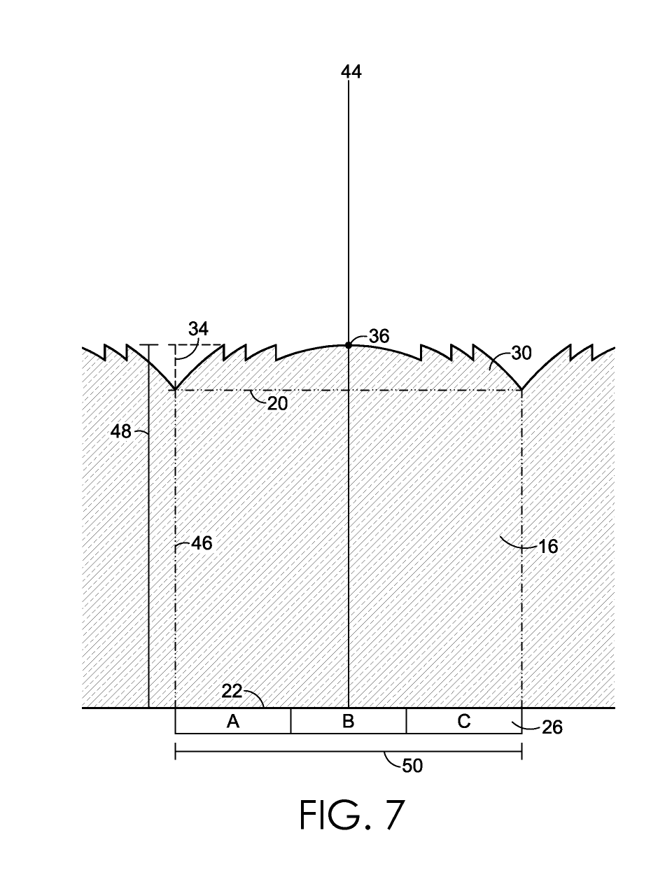

Turning to FIGS. 5, 6, and 7, a cross-section view of an exemplary lenticular lens of a lenticular array 14 as a material 18 for a shoe upper 12 is shown. In FIG. 5, a cylindrical lens shape is depicted. In FIG. 6, a hyperbolic or elliptic lens shape is shown. In FIG. 7, a Fresnel lens shape is shown. As such, any convex lens shape may be employed by the lenticular material 18. Different mediums, shapes, sizes, bases, and heights of a lens may be used to achieve the desired optical effects and the desired primary graphical elements via deformation.

In FIGS. 5, 6, and 7, the lenticular material 18, as illustrated, includes at least one lenticular lens and a substrate 16. The cross-section view of the lens is depicted as bisected by a principal axis 44, for clarity. And although the lens 30 is shown as intact, the lens may include one or more deformed portions. The substrate 16 has a height 46, and the lens 30 has at least one height 34 and 40. The thickness 48 of the lenticular material 18 accounts for both the height 46 of the substrate 16 and at least one height 34 and 40 of the lens 30. The width 50 of the lens 30, in cross section, may be used to determine the pitch of the lenticular material 18. For example, pitch may be defined as the number of lenses or lenticules per inch of the lenticular material 18. Additionally, the pitch may also be used to determine the widths of long, narrow image strips A, B, and C, for example, forming part of the graphical elements 26 affixed to the second surface 22 of the substrate 16 opposite each lens, wherein each image strip A, B, and C corresponds to a particular image and/or a particular viewing angle from which the corresponding image strip is visible to a user.

In FIG. 5, an exemplary full angle of observation 52 of the lens 30 is indicated, wherein the full angle of observation 52 generally includes more than one viewing angle when the lens 30 is not deformed. As previously explained, a viewing angle determines which image strip and which complete image may be visible to an observer. However, when the lens 30 is deformed, the full angle of observation 52 of the lens 30 may be reduced, and/or the number of viewing angles within the full angle of observation 52 may be reduced as well. In one aspect, when a lens is deformed in a uniform manner similar to the deformation illustrated in FIG. 3B, for example, the full angle of observation 52 and/or the number of viewing angles may be reduced. For example, the full angle of observation 52 may be equal to a single viewing angle. In another aspect, when a lens is deformed in an uneven or jagged manner similar to the deformation illustrated in FIG. 3C, for example, the full angle of observation 52 may be reduced (i.e., narrowed) and/or the number of viewing angles may be reduced as well. For example, the full angle of observation 52 may be reduced and the visibility of an image strip and/or a particular complete image of the array 14 through a corresponding viewing angle may be limited and/or destroyed. Additionally and/or alternatively, one or more portions of the lens 30 may be intentionally deformed to reduce or impair visibility of a particular image strip and/or complete image within the graphical elements 26 affixed to the second surface 22 of the substrate 16. In aspects, one or more portions are intentionally deformed to create eye-catching primary graphical elements independent of the underlying graphical elements 26 images. In some aspects, portions are deformed in particular areas of the lenticular material 18 so that the primary graphical elements are enhanced by the graphical elements 26 affixed to the second surface 22 of the substrate 16.

The optical mechanics of deformed portions may be apparent to those having skill in the art and, as such, will only be addressed briefly herein. Importantly, the factors discussed hereinafter may be utilized to determine aspects of deformation of one or more portions of at least one lens in the array 14. Each lens in the array 14, being similar in size, shape, and configuration, has the same or similar optics, such as back focal length. The back focal length generally describes the distance from the vertex of the last optical surface (e.g., the surface of the lens) to the image plane of the lens, wherein a vertex describes to a maximum or a minimum of the curvature of the lens, for example. In terms of the exemplary lens 30 of FIG. 5, the back focal length describes the distance from the apex 36 of the curvature of the lens 30 on the first surface 20 of the substrate 16 to the second surface 22 of the substrate 16 directly opposing the apex 36. With regard to lenticular arrays in general, the back focal distance of an exemplary array generally corresponds to and coincides with the second surface 22 of the substrate 16 and the location of the graphical elements 26 affixed thereon, for instance. Thus, each lens of the array focuses on one or more graphical elements 26 affixed to the second surface 22 opposite the lens 30, making said graphical elements 26 visible to an observer depending on viewing angle.

As will be apparent to those having skill in the art with regard to an exemplary lenticular array, the back focal length (BFD) may equal to the focal length (f) of the lenticular lens less the thickness (e) of the lenticular lens together with the substrate as divided by the refractive index (n) of the medium of the lens and the substrate. A very simplified formula may be illustrated as:

$$BFD = f - ( \frac{e}{n} ) .$$

Using back focal length, an appropriate and functional thickness of the array 14 may be determined so that it coincides with the second surface 22. Accordingly, the thickness of the transparent or semi-transparent materials of the array 14 may further be determined by the type, shape, and/or size of lenses within the array 14, the desired function of the lenses within the array 14, the optical power of the individual lenticular lenses, and the refractive index of the substrate 16 and lenses, among other factors. The medium of the semi-transparent or transparent substrate 16 and lenses have a refractive index that quantifies or measures the bending of light as it travels through each. However, the refractive index of the substrate and the lenses is just one factor used to determine a functional and/or optimal thickness, or a range of thickness, of the array 14 such that optical effects may be achieved by focusing the lenses on the graphical elements 26 of the second surface 22.

Additionally, the optical power of each of the plurality of lenses 24 of the array 14 is also used to calculate an appropriate thickness for the array 14. Generally, a mathematical relationship, known to those having skill in the art, exists between the thickness of the lenticular material 18 and the radius (or radii) of the curvature of a lens. The radius (or radii) of curvature generally refers to the distance from a vertex on the first optical surface of a lens to the center of the curvature of said lens. The radius factors into determining the focal length (f) and the back focal length (BFD) of the lens. As such, the lens of FIG. 5 may have a radius of curvature where the curvature is spherical, such that the focal length (f) is defined as

$$f = \frac{r}{n - 1} ,$$

for example. In contrast, the lens of FIG. 6 may have radii of curvature where the curvature is not spherical, such that the focal length (f) is best expressed using optical power (P). As will be apparent to those skilled in the art, optical power (P) is defined as the reciprocal of the focal length (f), which may be expressed as: P=1/f. As such, the focal length (f) of a non-spherical lens may be expressed as 1/f=(n−1)d/nR₁R₂, where R₁ and R₂ are radii of the curvature. This expression has been simplified for clarity. These and other optical equations may be used to determine the placement and extent of deforming at least a portion of a lens so as to impede an optical effect. For example, aspects of deformation may be determined depending on the desired amount or level of disruption to apply to a first optical effect, such that the optical effect is no longer visible to an observer at a particular viewing distance from the lenticular array 14, for example. Additionally or alternatively, the number of portions of a lens surface to deform; the size, shape, and/or uniformity of any deformations; and further, the location of placement of portions to be deformed may be determined based on the qualities of the lens (e.g., base 32, height, curvature, pitch, back focal distance, focal length, refractive index). It should be noted that different optical mechanics specifically apply to the Fresnel lens of FIG. 7 that will be known to those skilled in the art and, therefore, not discussed in detail here.

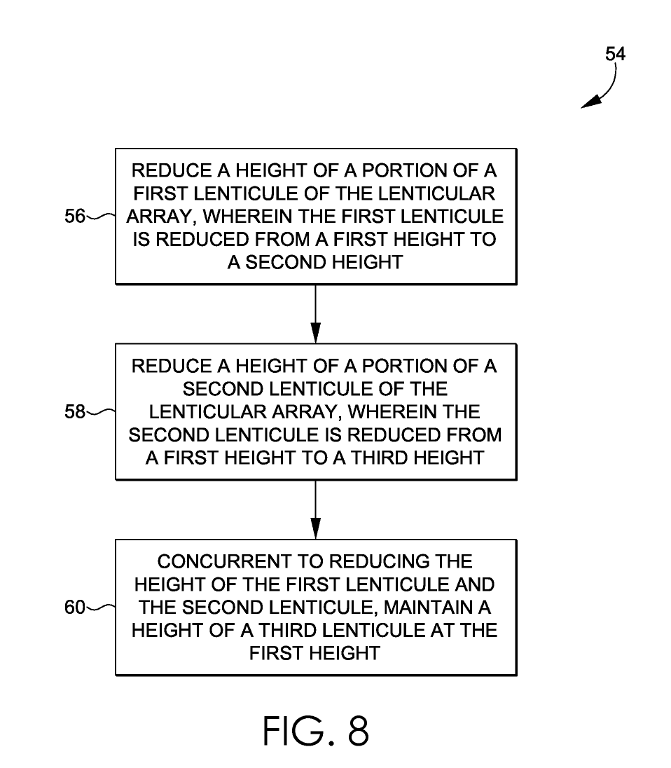

At FIG. 8, a method 54 for deforming a lenticular array 14 is illustrated. The method 54 will be described with general reference to exemplary structure previously described regarding FIGS. 3A-C. Generally, a plurality of lenticules of the same or similar size and shape extend upward from the first surface 20 of a substrate 16. The method 54 includes, at block 56, reducing a height of a portion of a first lenticule of the lenticular array 14. The portion of the first lenticule is reduced from a first height 34 to a second height 40. The height reduction may be achieved using any of the reduction and/or subtraction methods previously described herein. At block 58, the method further includes reducing a height of a portion of a second lenticule of the lenticular array 14. The portion of the second lenticule is reduced from the first height 34 to a third height. In embodiments, the second height 40 is not the same as the third height such that, after height reduction, the first lenticule is not the same height as the second lenticule. For example, when height reductions are jagged or uneven, the second height 40 may be different than the third height. Alternatively, the second and third heights may be the same, or negligibly similar in height. In some aspects, the second and third heights are not the same; however, both the second and third heights are within a particular height range, are at or below a height threshold, or are within a range of heights such that the second and third heights disrupt, at least partially, a first optical effect of the lenticular array 14 with regard to the first and second lenticules.

The method 54 further includes maintaining a height of a third lenticule at the first height 34, at block 60. The maintenance of the first height 34 with regard to the third lenticule may be concurrent to the height reduction of the first lenticule, to the height reduction of the second lenticule, or both, in aspects. As such, the method reduces the height of at least a portion of each of two lenticules while maintaining a third lenticule at the first height 34. As such, the third lenticule is not deformed but intact and, thus, retains function regarding the first optical effect that applies to the graphical elements 26 affixed to the second surface 22 of the substrate 16 of the lenticular material 18. The first and second lenticules, being reduced in height, are deformed. Thus, the first and second lenticules may form portions of, or contribute to, primary graphical elements that are accentuated by the first optical effect created by nearby or surrounding intact portions of lenticules.

The present aspect has been described in relation to particular examples, which are intended in all respects to be illustrative rather than restrictive. From the foregoing, it will be seen that this aspect is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. An array of lenticular lenses, the array comprising:
a plurality of evenly spaced repeating lenses extending from a substrate having a thickness, each lens of the plurality of lenses having a similar partial elliptic cross section about a lengthwise axis of each of the plurality of lenses, wherein each of the plurality of lenses extends along their respective lengthwise axis forming partial elliptic cylinders, each partial elliptic cross section having a base and a first height extending from the substrate, and wherein at least a portion of a partial elliptic cross section of a first lens of the plurality of lenses is deformed to a second height.

2. The array of claim 1, wherein the lenses are parallel along the lengthwise axis.

3. The array of claim 1, wherein the lenses are magnifying.

4. The array of claim 1, wherein the substrate is at least partially transparent.

5. The array of claim 1, wherein the substrate has a first surface and a second surface, the first surface comprising the plurality of lenses and the second surface opposing the first surface.

6. The array of claim 1, wherein a graphical element is affixed to the second surface of the substrate.

7. The array of claim 1, wherein the elliptic cross section about the lengthwise axis is circular or defined by a major and minor axis.

8. The array of claim 1, wherein the deformation of the first lens reduces one or more of a full angle of observation or a viewing angle of the first lens.

9. The array of claim 8, wherein the viewing angle of the first lens corresponds to one complete image cycle.

10. The array of claim 1, wherein the first height corresponds to a first radius and the second height corresponds to a second radius, and wherein the second radius is less than the first radius.

11. An array of lenticular lenses, the array comprising:
a plurality of evenly spaced repeating lenses extending from a substrate having a thickness, each lens of the plurality of lenses having a similar cross section about a lengthwise axis of each of the plurality of lenses, wherein each of the plurality of lenses extends along their respective lengthwise axis, each cross section having a base and a first height extending from the substrate, and wherein at least a portion of cross section of a first lens of the plurality of lenses is deformed to a second height.

12. The array of claim 11, wherein the lenses are parallel along the lengthwise axis.

13. The array of claim 11, wherein the at least a portion of the cross section of a first lens is deformed perpendicular to the cross section.

14. The array of claim 11, wherein the at least a portion of the cross section of a first lens that is deformed is placed such that the deformed portion limits an angle of observation of the first lens.

15. The array of claim 11, wherein the at least a portion of the cross section of a first lens is deformed such that the deformed portion is centrally located near the apex of the first lens when viewed in cross section.

16. The array of claim 11, wherein the at least a portion of the cross section of a first lens is deformed such that the deformed portion is peripherally located when viewed in cross section.

17. The array of claim 11, wherein the at least a portion of the cross section of a first lens is uniformly deformed when viewed in cross section.

18. The array of claim 11, wherein each of the plurality of evenly spaced repeating lenses is convex.

19. The array of claim 11, wherein the lenticular material is one of a flip, shift, morph, animation, or three-dimensional type.

20. A method of deforming a portion of an array of lenticular lenses, the method comprising:
reducing a height of a portion of a first lenticule of the array of lenticular lenses, wherein the first lenticule is reduced from a first height to a second height;
reducing a height of a portion of a second lenticule of the array of lenticular lenses, wherein the second lenticule is reduced from a first height to a third height; and
concurrent to reducing the height of the first lenticule and the second lenticule, maintaining a height of a third lenticule at the first height.
